(19) United States
(12) Patent Application Publication
(10) Pub. No.: US 2002/0063896 A1
(43) Pub. Date: May 30, 2002

(54) In an electronic reprographic system, provide automatic document integrity determination and page organization

(75) Inventors: Eugene A. Rogalski JR., Rochester, NY (US); Wayne A. Buchar, Bloomfield, NY (US); David L. Salgado, Victor, NY (US)

Correspondence Address: Albert P. Sharpe, III, Esq., Fay, Sharpe, Fagan, Minnich & McKee, LLP, 1100 Superior Avenue, 7th Floor, Cleveland, OH, 44114-2518, US

(73) Assignee: XEROX CORPORATION

(21) Appl. No.: 09/726,104

(22) Filed: Nov. 29, 2000

(51) Int. Cl. B41B 1/00; G06F 15/00

(52) U.S. Cl. 358/1.18

(57) ABSTRACT

An electronic reprographic system and method are provided that extend the functionality of reprographic systems. The system includes an input system for converting contents of a multi-page document to a plurality of digital representations in a storage system, a processing system that generates processed digital representations in the storage system, a user interface for posting document integrity messages to a user and inputting user responses to the messages, and an output system for outputting the processed digital representations. The processing system includes a character recognition module, a reference number locator module, a page sequence integrity determinator module, a page insertion module, a page deletion module and a page reordering module. The aforementioned reference number can be a page number, column number or line number, each of which can be in any common format such as Roman numeral and alphanumeric. The reprographic system includes functionality to automatically reorder pages, insert pages and delete pages.

### BACKGROUND OF THE INVENTION

This invention is directed to electronic reprographic systems (copiers). Presently, users typically place a stack of originals (a document) in a document feeder (input system) and expect copies to come out perfectly reproduced on the output tray of the system. Several conditions can contribute to copier equipment failing to meet this expectation. Misfeeds, multifeeds, missing pages, incorrectly ordered pages and improper orientation all potentially contribute to an imperfect copy of the original document. Typically, the only way to determine integrity of the copy is to verify the original job integrity and to proof a sample of the output copies. For large sets, users often do not take the time to pre-proof the job, but are often frustrated by having to determine the cause once a problem has arisen. The marriage of digital copiers with fax, network and repository storage systems has only exacerbated the aforementioned problems.

It would be desirable, therefore, to provide enhanced intelligence and functionality for electronic reprographic systems to automatically detect page integrity of an input document. It would also be desirable to provide functionality to correct integrity problems, where possible, without rescanning the entire input document.

### SUMMARY OF THE INVENTION

The present invention comprises an electronic reprographic system and method that extend the functionality of reprographic systems. The system includes an input system for converting contents of a multi-page document to a plurality of digital representations in a storage system, a processing system, operatively connected to the storage system and the input system, that generates processed digital representations in the storage system, a user interface operatively connected to the processing system for posting document integrity messages to a user and inputting user responses to the messages, and an output system operatively connected to the storage system for outputting the processed digital representations. The processing system includes a character recognition module, a reference number locator module, a page sequence integrity determinator module, a page insertion module, a page deletion module and a page reordering module. The aforementioned reference number is typically a page number, column number or line number which can be in any common format such as Roman numeral and alphanumeric. The reprographic system includes functionality to automatically reorder pages, insert pages and delete pages.

### DESCRIPTION OF THE DRAWINGS

The present invention exists in the construction, arrangement, in combination of the various parts of the device, and steps of the method, whereby the objects contemplated are attained as hereinafter more fully set forth, specifically pointed out in the claims, and illustrated in the accompanying drawings in which:

FIG. 1 illustrates a preferred embodiment of the present invention;

FIG. 2 is a flow diagram of an embodiment of the present invention;

FIG. 3 is a flow diagram of an option of an alternate embodiment of the present invention;

FIG. 4 is a flow diagram of a second option of an alternate embodiment of the present invention; and,

FIG. 5 is a flow diagram of a third option of an alternate embodiment of the present invention.

### DETAILED DESCRIPTION OF THE PREFERRED EMBODIMENTS

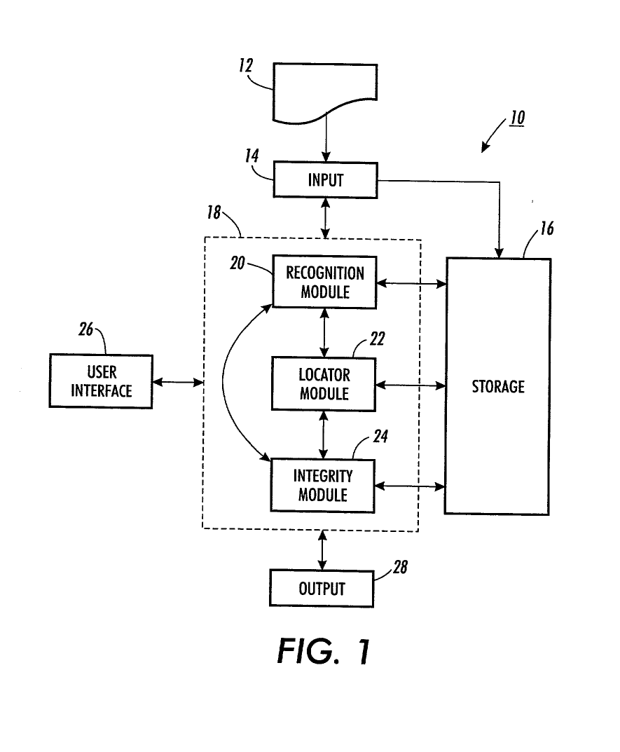

FIG. 1 shows a schematic representation of an electronic reprographic system 10 incorporating a preferred embodiment of the present invention. A page of document 12 is scanned and converted to a digital representation by input system 14 which is operatively connected to a storage system 16 and a processing system 18. Input system 14 stores the digital representation of each page of document 12 in storage system 16, and processing system 18 performs integrity analysis of document 12 by processing the digital representation of each page of document 12 in storage system 16.

Processing system 18 includes a recognition module 20, a locator module 22 and an integrity module 24. Recognition module 20, in operative connection with storage system 16, performs character recognition analysis of the digital representation of each page of document 12 using well known optical character recognition (OCR) and/or intelligent character recognition (ICR) techniques, and stores recognized characters in storage system 16 in ASCII character form or other readable format. Locator module 22, also in operative connection with storage system 16, performs heuristic analysis of the recognized characters in order to locate a reference number, typically a page number, scanned from each page of document 12. Integrity module 24, likewise in operative connection with storage system 16, performs a page sequence integrity determination and performs corrective processing on the digital representation of document 12, producing a processed digital representation, and, through an operative connection with a user interface 26, displays integrity messages to a user and is responsive to input from a user at user interface 26.

After integrity module 24 determines that document 12 has good page integrity, or receives approval from a user at user interface 26, processing system 18 sends the processed digital representation to output system 28. Output system 28 is typically configured as a printing system. While recognition module 20, locator module 22 and integrity module 24 were described as being in operative connection with storage system 16, they can alternately, and/or additionally, be in operative communication with each other as shown in FIG. 1.

While locator module 22 would typically scan the margins of document 12 for page number information, in another embodiment of the invention, locator module 22 would optionally scan user designated areas of each page for sequence numbers. A further embodiment would also scan for alternate sequence number types such as column numbers and line numbers and would also have the capacity to interpret a plurality of alternate numbering formats, in addition to numeric formats, such as Roman numeral and alphanumeric formats. It is to be appreciated that the present invention is not limited to the aforementioned sequence number types. Integrity module 24 could determine the integrity of section numbers, chapter numbers, tables of content, indexes and any rule-based document numbering scheme.

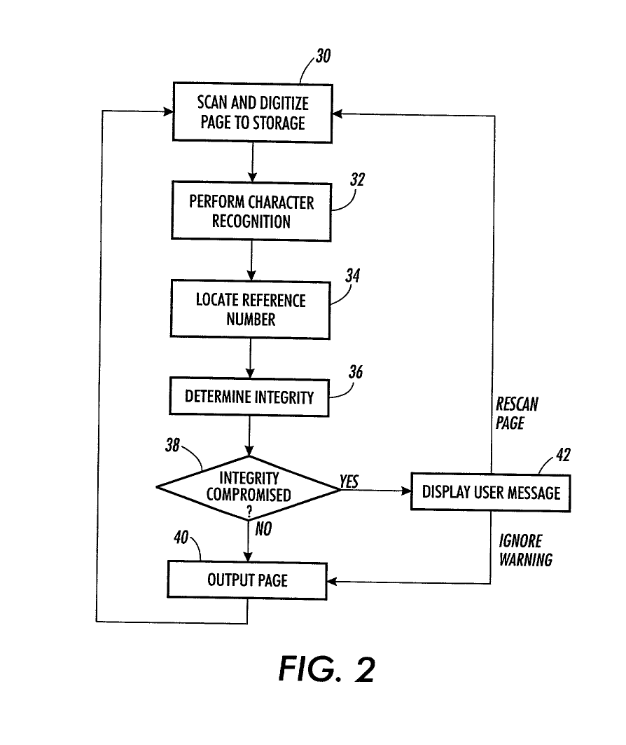

FIG. 2, with continuing reference to FIG. 1, presents a flow chart of an embodiment of the present invention as might be utilized on an electronic reprographic system. Step 30 utilizes input system 14 to scan and store a digital representation of a page of document 12 in storage system 16. Step 32 subsequently performs OCR analysis of predefined areas of the stored digital representation, and step 34 then performs a heuristic analysis of the recognized characters generated by step 32 to locate a reference number.

After step 34 has successfully located a reference number, step 36 analyzes the reference number to determine page sequence integrity, and decision step 38 takes alternate paths dependent on the analysis by step 36. If page sequence integrity is determined not to be compromised, processing continues at step 40, where output system 28 is used to output the digital representation to a preferred medium, typically a printed page. If, however, page sequence integrity has been determined to be compromised, step 42 displays a user message on user interface 26 and waits for a response from a user at user interface 26. A user may wish to ignore the message in which case processing continues with step 40 to output the digital representation. A user might also wish to correct the sequence of document 12 in which case processing continues at step 30 to rescan a page of document 12.

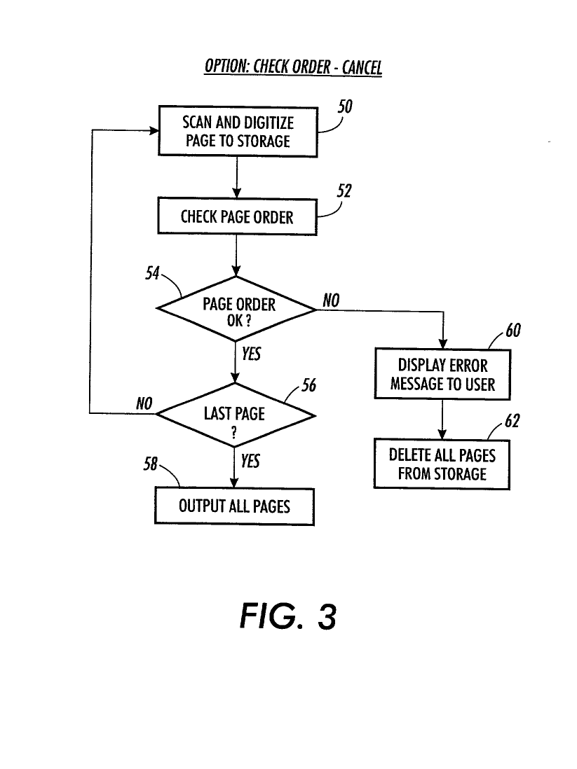

The embodiment illustrated in FIG. 2 has the capability to detect missing, duplicated and out-of-order pages of a document, however, it does not have the capability to automatically reorder a document or other corrective actions after a document has been scanned. The embodiment therefore has described a simple one page in, one page out system. A further embodiment of the present invention scans an entire document before printing the digital representations of the document's pages and therefore is able to perform a variety of corrective actions before releasing the stored digital representations to the output system. For example, an electronic reprographic system could have user selected page number checking options such as “off”, “check order—cancel”, “check order—hold” and “check order—automatically reorder.” The “off” option allows for turning off page number checking. The remaining options are discussed with respect to FIGS. 3-5.

FIG. 3 is a flow diagram illustrating the “check order—cancel” option. With continuing reference to FIGS. 1 and 2, step 50 utilizes input system 14 to scan and store a digital representation of a page of document 12 in storage system 16. Step 52, check page order, comprises steps 32, 34 and 36 of FIG. 2, performing OCR analysis, locating a reference number, and determining page order integrity. Decision step 54 causes processing to continue at decision step 56 if page order integrity is not compromised. Decision step 56 subsequently causes processing to continue iteratively at step 50 if there are remaining pages to be scanned in input system 14. If the last page has been scanned, processing continues at step 58 wherein all stored digital representations of the pages of document 12 are submitted to output system 28 where they typically are printed.

If, however, decision step 54 determined that page order integrity was compromised, processing continues at step 60, wherein an error message is displayed to a user at user interface 26. Step 62 deletes all stored digital representations from storage, and no digital representations is submitted to output system 28, effectively canceling the reprographic job.

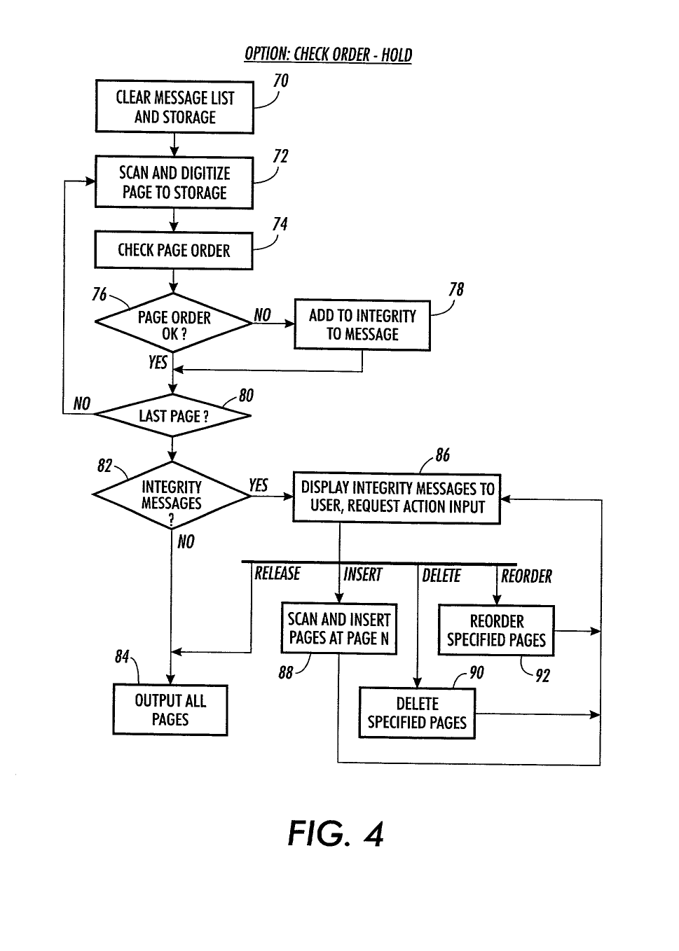

FIG. 4 is a flow diagram illustrating the “check order—hold” option. Step 70 clears storage system 16 of all messages in a message list and any prior digital representations. Step 72 utilizes input system 14 to scan and store a digital representation of a page of document 12 in storage system 16. Step 74 checks page order in a manner comparable to step 52 of FIG. 3. Decision step 76 then invokes step 78 if page order integrity has been compromised, and step 78 adds a message, describing the page order integrity compromise, to a message list. Processing continues to step 80, which iteratively causes processing to continue at step 72 if there are pages of document 12 remaining in input system 14, and causes processing to continue at decision step 82 if there are no pages remaining.

Decision step 82 allows processing to continue at step 84 if there are no messages in the aforementioned message list, and step 84 submits all stored digital representations to output system 28. If, however, decision step 82 determined that the message list was not empty, processing is directed to continue at step 86, wherein the message list is displayed to a user at user interface 26. Step 86 pauses, waiting for a user response from user interface 26, and take one of four possible actions depending on whether the response was “release”, “insert”, “delete” or “reorder.” If the response was “release”, processing continues at step 84 as if no page order integrity problems existed. The remaining responses all require processing activity.

A user response of “insert” invokes step 88 wherein additional pages are scanned and stored in storage system 16, inserted after a user specified page N. Integrity determination is performed during this scanning process in a manner similar to steps 72-80. Additional messages are added to the message list if integrity violations are encountered. Processing then iteratively returns to step 86 to await further responses from user interface 26. A “delete” response provides, at step 90, for the deletion of user specified pages from storage system 16. Again, processing iteratively returns to step 86 to await further responses from user interface 26. A “reorder” response invokes step 92 wherein user specified pages would be sorted within storage system 16, and once again, processing iteratively returns to step 86 to await further responses from user interface 26. It is to be appreciated that the four discussed responses are exemplary responses only, and the scope of the present invention is not limited to these responses. For example, additional functionality can be provided to sort pages in descending page number sequence, to rearrange chapters, to perform another page integrity check by scanning all digital representations stored in storage system 16, and so forth.

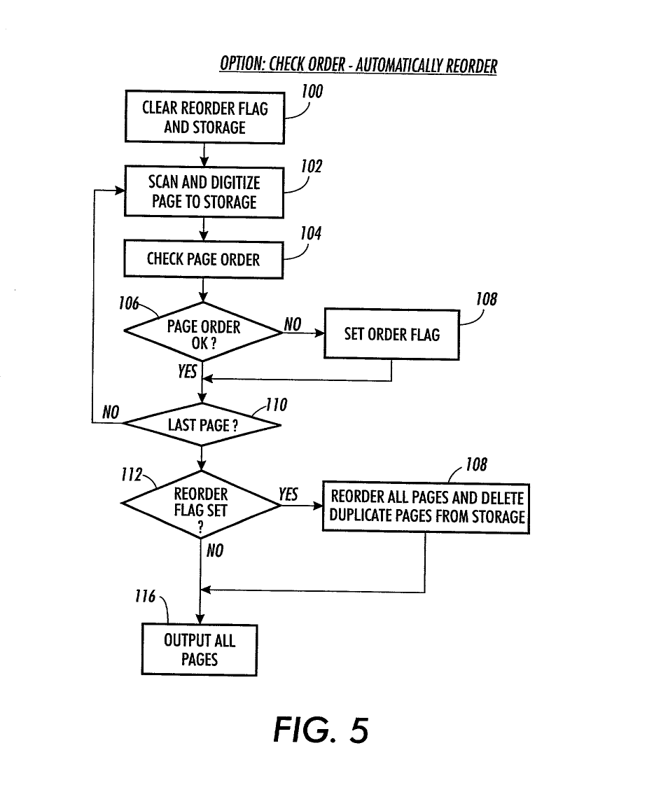

FIG. 5 is a flow diagram illustrating the “check order—automatically reorder ” option. Step 100 clears storage system 16 of a reorder flag and any prior digital representations. Step 102 utilizes input system 14 to scan and store a digital representation of a page of document 12 in storage system 16. Step 104 checks page order in a manner comparable to step 52. Decision step 106 then invokes step 108 if page order integrity has been compromised, and step 108 sets a reorder flag in storage system 16. Processing continues at step 110. Decision step 110 iteratively causes processing to continue at step 102 if there are pages of document 12 remaining in input system 14, and causes processing to continue at decision step 112 if there are no pages remaining. Decision step 112 invokes step 114 to reorder all digital representations in storage system 16 by sorting the representations in ascending sequence within storage system 16. Step 116 then submits stored digital representations to output system 28 for final processing, typically a printing process.

It is to be appreciated that the four processing options described above, namely “off”, “check order—cancel”, “check order—hold” and “check order-automatically reorder”, are software based and, therefore, not limited in scope. Other useful options with respect to electronic reprographic systems could easily be programmed into processing system 18.

The invention has been described with reference to the preferred embodiments. Obviously, modifications and alterations will occur to others upon a reading and understanding of this specification. It is intended to include all such modifications and alterations insofar as they come within the scope of the appended claims or the equivalents thereof.

Having thus described the invention, we hereby claim:

1. An electronic reprographic system comprising:
an input system for converting contents of a document page to a digital representation;
a storage system operatively connected to said input system for storing said digital representation;
a processing system operatively connected to said storage system and said input system comprising:
a character recognition module;
a reference number locator module; and,
a page sequence integrity determinator module;
a user interface operatively connected to said processing system for posting document integrity messages to a user and inputting user responses to said messages; and,
an output system operatively connected to said storage system and said processing system for outputting said digital representation.

2. The electronic reprographic system as set forth in claim 1, wherein said reference number comprises a page number.

3. The electronic reprographic system as set forth in claim 1, wherein said reference number comprises a column number.

4. The electronic reprographic system as set forth in claim 1, wherein said reference number comprises a line number.

5. The electronic reprographic system as set forth in claim 1, wherein said reference number is of one or more formats selected from:
Roman numeral; and,
alphanumeric.

6. The electronic reprographic system as set forth in claim 1, wherein said output system comprises a printer.

7. An electronic reprographic system comprising:
an input system for converting contents of a multi-page document page to a plurality of digital representations;
a storage system operatively connected to said input system for storing said digital representations;
a processing system operatively connected to said storage system and said input system for generating processed digital representations comprising:
a character recognition module;
a reference number locator module;
a page sequence integrity determinator module;
a page insertion module;
a page deletion module; and,
a page reordering module;
a user interface operatively connected to said processing system for posting document integrity messages to a user and inputting user responses to said messages; and,
an output system operatively connected to said storage system for outputting said processed digital representations.

8. The electronic reprographic system as set forth in claim 7, wherein said reference number comprises a page number.

9. The electronic reprographic system as set forth in claim 7, wherein said reference number comprises a column number.

10. The electronic reprographic system as set forth in claim 7, wherein said reference number comprises a line number.

11. The electronic reprographic system as set forth in claim 7, wherein said reference number is of one or more formats selected from:
Roman numeral; and,
alphanumeric.

12. The electronic reprographic system as set forth in claim 7, wherein said output system comprises a printer.

13. On an electronic reprographic system a method for determining document integrity comprising:
converting contents of one or more document pages to digital representations;
storing said digital representations in a storage system;
processing said storage system, said processing comprising the steps of:
generating characters by performing a character recognition algorithm on said digital representations;
locating reference numbers among said characters; and,
determining page sequence integrity by examining said reference numbers;
posting document integrity messages to a user and inputting user responses to said messages on a user interface; and,
outputting said digital representations.

14. The method as set forth in claim 13, wherein said step of processing further comprises the steps of:
inserting missing pages in said storage system;
deleting duplicate pages from said storage system; and,
reordering pages in said storage system;

15. The method as set forth in claim 13, wherein said reference number comprises a page number.

16. The method as set forth in claim 13, wherein said reference number comprises a column number.

17. The method as set forth in claim 13, wherein said reference number comprises a line number.

19. The method as set forth in claim 13, wherein said outputting comprises printing.

20. The method as set forth in claim 13, wherein said reference number is of one or more formats selected from:
Roman numeral; and,
alphanumeric.
